(19) United States
(12) Patent Application Publication
(10) Pub. No.: US 2021/0201270 A1
(43) Pub. Date: Jul. 1, 2021

(54) MACHINE LEARNING-BASED CHANGE CONTROL SYSTEMS

(71) Applicant: Oracle International Corporation, Redwood City, CA (US)

(72) Inventors: David Cross, Bellevue, WA (US); Yibin Liao, Bellevue, WA (US)

(21) Appl. No.: 16/731,704

(22) Filed: Dec. 31, 2019

(51) Int. Cl. G06Q 10/10; G06K 9/62; G06N 20/00

(52) U.S. Cl. CPC G06Q 10/1053; G06N 20/00; G06K 9/6232; G06K 9/6215

(57) ABSTRACT

Various embodiments of the present technology generally relate to systems, tools, and processes for change control systems. More specifically, some embodiments relate to machine learning-based systems, methods, and computer-readable storage media for job approvals, logging, and validation of critical functions and tasks based on compliance requirements, threat models, intended outcomes, rules, regulations, and similar restrictions or combinations thereof. Job approvals, rejections, and deferrals may be combined with machine learning techniques to conduct behavioral analysis in some implementations. The system disclosed herein provides for an improvement over existing change control methods requiring manual and time-consuming analysis. The system utilizes a combination of security, compliance, and auditing requirements along with machine-learning based behavior analysis of development, security, and operations functions and actions to determine risk, rejection, approval, or deferral of submissions in an automated manner.

### TECHNICAL FIELD

Various embodiments of the present technology generally relate to change control systems, tools, and processes for performing approval and logging of functions and tasks in all types of cloud datacenters. More specifically, the present technology provides a control point for a change control system for risk-based decision making based on compliance requirements, rules, regulations, and intelligent behavioral analysis.

### BACKGROUND

Operations functions, tasks, and processes are prone to errors, malicious behaviors, and non-compliant actions due to ineffective analysis, alerting, and controls. Present day cloud operations actions require manual and time-consuming analysis against compliance requirements, threat models, intended outcomes, and validation of proposed changes. Cloud operations functions may be urgent, such as outage-based actions, making it difficult or impossible to complete the manual actions required in the time permitted, leaving room for mistakes or gaps in protection.

Change control systems serve as an important line of defense for a system by attempting to reduce the possibility that harmful, problematic, or unnecessary changes are introduced to the system. Change control systems are used for evaluating submitted changes, code, configurations, and similar submissions through a process that may record proposed changes, require approver entities, and document results based on submissions. Cloud operations system may use change control systems, tools, and processes to perform approvals and logging of critical functions and tasks in datacenters. While change control systems, in general, serve to protect systems from unwanted or harmful changes, they are often largely based in manual revision processes, making them error-prone and time-consuming.

Thus, the system disclosed herein provides for an improvement over existing change control methods and utilizes a combination of security, compliance, and auditing requirements with machine-learning based behavior analysis to perform risk-determinations, rejections, approvals, or deferrals in an automated manner. The present system may assist in avoiding unnecessary disruption to services when implementing change by determining the scope of the changes, analyzing changes, approving or rejecting changes, testing changes, and implementing changes.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing change control processes. The present technology increases the reliability and security of potential cloud operations changes using automated analysis and compliance with defined security requirements. In a first embodiment, a change control system comprises one or more computer-readable storage media, a processing system operatively coupled with the one or more computer-readable storage media, and program instructions stored on the one or more computer-readable storage media. When read and executed by the processing system, the program instructions direct the processing system to receive a job submission, wherein the job submission comprises a job including at least one change to a component within a system associated with the change control system. Upon receiving the job, the program instructions further direct the processing system to generate a graph based on the job and then extract information from the graph for submission to a behavior analysis system, wherein the behavior analysis system is implemented using machine learning techniques. The machine learning model evaluates the information extracted from the graph to determine if the submission should be rejected. The program instructions then direct the processing system to submit information from the graph to an input layer of the machine learning model.

In some embodiments, the machine learning model includes at least one of an artificial neural network, gradient boosting decision trees, and an ensemble random forest. The machine learning model may determine a similarity score based on similarities between the information from the graph and information from previously rejected (or accepted) job submissions. Based on the similarity score and a set of defined thresholds, the change control system may accept the job submission, reject the job submission, or defer the job submission for further review. In some embodiments, the machine learning model is trained using historical change control system data wherein the historical change control system data includes previously rejected job submissions and previously accepted job submissions. In some embodiments, the graph comprises a plurality of nodes and a plurality of edges, the plurality of nodes and the plurality of edges comprising information about the job. Each node of the plurality of nodes may be based on learned attributes related to, at least in part, one or more users, components, timing attributes, or requirements. In certain embodiments, extracting information from the graph and submitting the information from the graph to the input layer of the machine learning model is based on a mapping of nodes from the graph to specific inputs of the input layer of the machine learning model.

In another embodiment of the present technology, a method of operating a change control system comprises receiving a job submission, wherein the job submission comprises a job including at least one change to a component within a system associated with the change control system. The method further includes, upon receiving the job submission, generating a graph based on the job, extracting information from the graph for submission to a machine learning model, and submitting the information from the graph to an input layer of the machine learning model. The machine learning model, in the present implementation, evaluates the information to determine if the submission should be rejected.

In yet another embodiment, one or more computer-readable storage media have program instructions stored thereon to facilitate change control processes for cloud operations functions. The program instructions, when read and executed by a processing system, direct the processing system to receive a job submission, wherein the job submission comprises a job including at least one change to a component within a system associated with the change control system. Upon receiving the job submission, the program instructions further direct the processing system to generate a graph based on the job, extract information from the graph for submission to a machine learning model, and submit the information from the graph to an input layer of the machine learning model. The machine learning model evaluates the information to determine if the submission should be rejected.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment comprising a change control system in accordance with some embodiments of the present technology;

FIG. 2 illustrates a change control process in accordance with some embodiments of the present technology;

FIG. 3 illustrates a change control analysis flow in accordance with some embodiments of the present technology;

FIG. 4 illustrates an example of a graph generated in a change control analysis process in accordance with some embodiments of the present technology;

FIG. 5 illustrates a failed submission change control flow in accordance with some embodiments of the present technology;

FIG. 6 illustrates a data modeling flow for a change control system in accordance with some embodiments of the present technology;

FIG. 7 illustrates a data modeling process for classifying job submissions in accordance with some embodiments of the present technology;

FIG. 8 illustrates a process for inputting job information into a machine learning structure in accordance with some embodiments of the present technology;

FIG. 9A illustrates an example of determining a similarity score for a job in accordance with some embodiments of the present technology;

FIG. 9B illustrates a numerical example of determining a similarity score for a job in accordance with some embodiments of the present technology; and

FIG. 10 illustrates a computing system for implementing change control processes in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Various embodiments of the present technology generally relate to change control systems, tools, and processes. More specifically, some embodiments relate to systems, methods, and computer-readable storage media for job approvals, logging, and validation of critical functions and tasks based on compliance requirements, threat models, intended outcomes, rules, regulations, and similar restrictions or combinations thereof. Job approvals, rejections, and deferrals are combined with machine learning techniques to conduct behavioral analysis in some implementations. The system disclosed herein provides for an improvement over existing change control methods requiring manual and time-consuming analysis. The system utilizes a combination of security, compliance, and/or auditing requirements with behavioral analysis of development, security, and operations functions and actions to determine risk, rejection, approval, or deferral in an automated manner. The system described herein may serve as a control point within a change control system but is not intended to be an overhaul or replacement of entire change control systems. Furthermore, while some examples provided herein are described in the context of cloud storage and/or datacenters, it should be understood the change control systems and methods described herein are not limited to such embodiments and may apply to a variety of other change control environments and their associated systems.

The present change control system is based on three major components: a change control system, a requirements list, and dynamic behavioral analysis. The change control system is an industry standard system for submitting changes, code, or configurations through a process that may record the proposed change, require approver entities, and document results based on the submission. The requirements list is a configured set of attributes defining controls to be analyzed and validated against any change, code, or configuration submitted to the change control system. The requirements list may be based on industry certifications, regulations, requirements, data points, or any other requirement entered or configured into the system. The dynamic behavior analysis component is based in machine learning methods. The analysis uses metadata or attributes from submissions to the change control system to perform anomaly detection and alerting of changes that might be suspicious, unusual, non-compliant, or high-risk compared to historically average or normal submissions. Machine learning methods may be used within the behavioral analysis system to perform approval, rejection, or deferral for further review.

In order to perform approval, rejection, and deferral processes, one or more machine learning models of the behavioral analysis component may be trained using historical change control data. Training data may be based on independent, parallel analysis of user roles, organizational structure, permissions, operational users in previous change control systems, operational functions that have historical failures, expected and historical review analysis time windows, or any other data relevant to the success or failure of historical change control submissions.

The machine learning-based trends and training data may use multiple metadata attributes that are modeled based on historical usage data in parallel. In no embodiments is the model a static list of comparisons based on specified or used attributes. The list of metadata attributes used may include but are not limited to the speed of approval after submission, organizational hierarchy or relationship to submitter, size of submission, lines of code, number of components or systems affected, historical ownership of components submitted, role of the user or submitter, logs of failed submission generating outages or operational failures, and other attributes that may affect a likelihood of failure or risk level.

Ultimately, the result of the behavior analysis is based on a calculated weighting of aggregate anomalies identified in the parallel attribute data analysis. A risk score and acceptance may be configured or set by users to determine an acceptable risk level based on the operational environment. In other implementations, acceptable risk may be determined by a trained behavior analysis model.

Training data may be used as input to a behavior analysis model, wherein the training data may be historical submission data including submissions that have failed, had unexpected results, generated outages or other anomalies, or produced other negative outcomes. Submissions may be labeled to identify correlations, component areas, or attribute changes that are similar and weighted as their risk level based on previous failures. Additional data labeling may include a specific line or lines of code, configurations, statements, incorrect attributes, corruption, or errors. Furthermore, training data may include data based on factors such as time of submission, reviewer or approver of submission, a number of contributors, and many other factors or combinations thereof. The input data may include date and time of submission, time zone, normal working hours, time to review, time to approve, time data based on length of code, user experience, number of reviews, or similar review-time related factors and combinations thereof. Labels, such as the labels discussed here, may be used to train and identify similar submissions that can be determined to be potential risks or anomalies.

Once the behavior analysis model has been trained using training data and training methods such as those already discussed, the behavior analysis component may perform weighted analysis of labeled components that match or are similar to previously failed components or areas. The weighting and analysis may then be evaluated against defined thresholds to determine if a submission should be approved or rejected. The defined thresholds may be set by administrators or learned by the system based on historical data and labeled submissions.

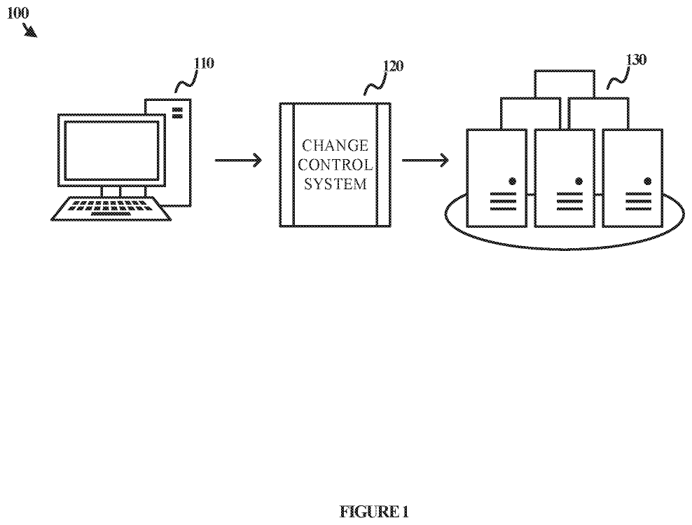

FIG. 1 illustrates operational environment 100 for implementing change control system processes in accordance with some implementations of the present technology. FIG. 1 includes change submission environment 110, change control system 120, and computing operations environment 130. In the present example, change submission environment 110 may submit a change package to change control system 120 and change control system 120 subsequently receives the change package submission. The change package may include a change package for any software environment associated with the change control system. In some examples, computing operations environment 130 is a cloud operations system. Many systems may be used to protect applications and data within a cloud environment. Changes to cloud environments such as the change package submission of the present example are submitted frequently, and ensuring that a change fits the compliance, auditing, and security requirements of a system is extremely important. Jobs submitted to a software environment such as a computing operations environment 130 may include changes to firewalls, routers, and other configurable systems whether based in hardware, software, or any combination thereof. Upon submission of a job, change control system 120 serves as an integration point and determines if the submission will fail or how the submission will affect compliance, audits, and security, among other concerns or requirements within computing operations environment 130. For example, if a change is submitted using cryptography with a non-approved or a weak algorithm, change control system 120 should not allow the change to go through or implement, regardless of whether the submission is accidental or malicious.

In response to receiving the change package submission, change control system 120 generates a graph based on the submission. The graph is a data structure used to represent attributes and relationships of the submission numerically with nodes and edges. The graph transforms data from the submission, which may be comprised in log files, text files, or other types of static files comprising information, into a usable form of information stored as metadata that can later be utilized for behavior analysis. Nodes within the graph represent attributes and may include names or labels and a set of features. The edges connecting nodes in the graph may be undirected or directed. In some examples, nodes and edges may be weighted according to various factors regarding how they affect the likelihood that a submission will fail.

Data from the submission is modeled in the graph in the form of metadata defining attributes relevant to the submission. For example, information that may serve as attributes based on the user or submitter may include email, name, validation information, submission date, submission time, the organization the user belongs to, and similar user-related properties. These properties may then be represented within the graph in nodes such as user nodes, organization nodes, submission date nodes, and others. The user nodes may assist in determining risk associated with a submission. For example, a correlation may be known or discovered that when a user is a contributor, but not a manager, their submissions are 99% successful. However, when a user is a manager, the success rate may be significantly lower, and the submission may be identified as high-risk.

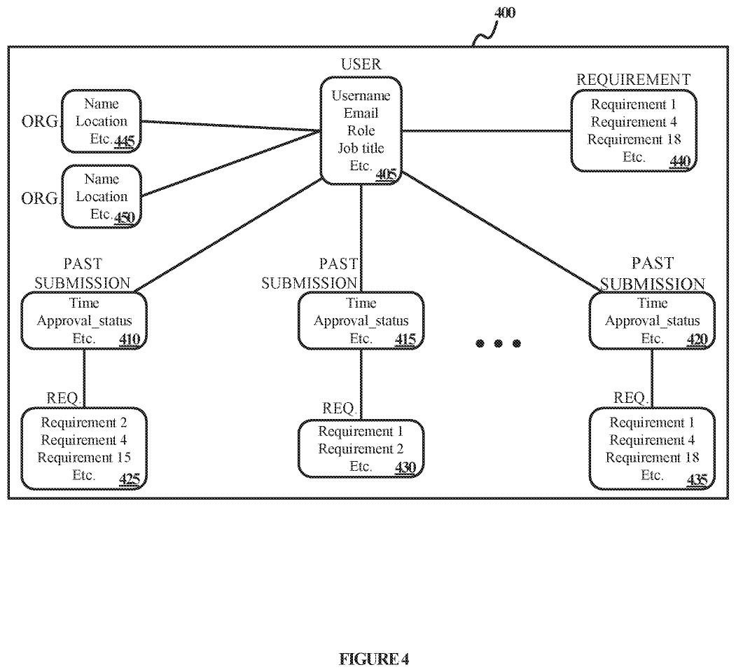

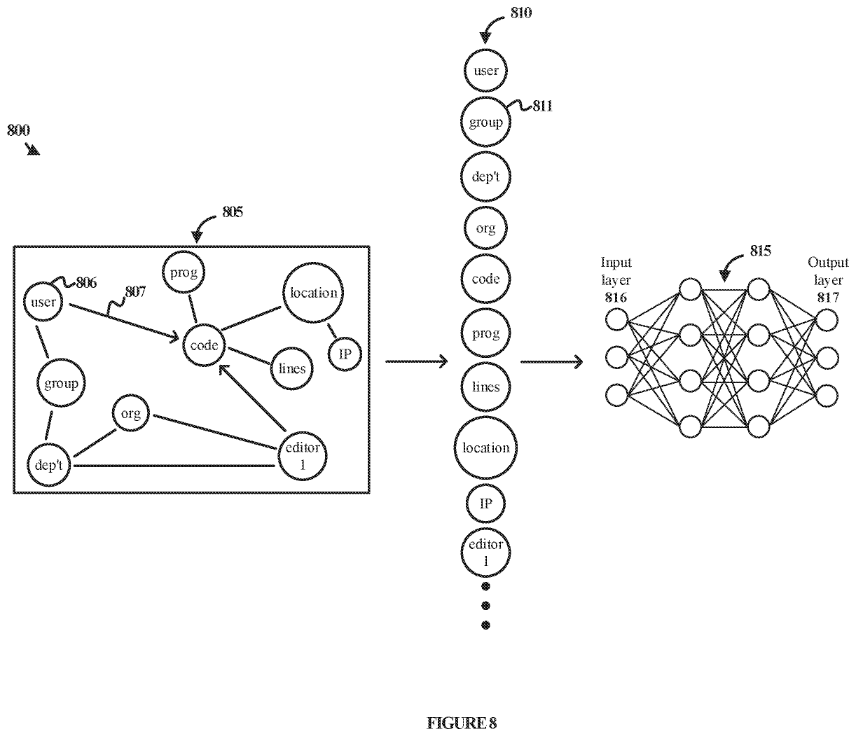

Nodes representing metadata attributes may populate the graph with any information extracted from the submission package. Edges may connect nodes within the graph to further represent the information. For example, an edge may exist between a user node and an organization node demonstrating that the user belongs to that organization. Once the graph is populated, the submission is fully represented within the graph. Based on previous submissions, change control system 120 may use the graph to determine similarities between the submission and previous submissions to make a prediction as to whether or not the submission will fail and/or if it should be rejected, allowed, or passed on for further review. The graph may be described in more details with reference to FIGS. 4 and 8.

Once the graph is populated with information describing the submission, change control system 120 extracts features from the generated graph. Features extracted from the graph may include all features represented in the graph or only a subset of features, wherein the features include information from both nodes and edges of the graph. Features may be extracted based on inputs to a machine learning model, in some embodiments. The extracted features are then input into a machine learning module for behavior analysis.

In the present example, the machine learning module comprises a machine learning algorithm that is already trained based on historical submissions. The machine learning module may employ one or more machine learning algorithms through which attributes may be analyzed to determine if the submission should be rejected, accepted, or needs additional review. Examples of machine learning algorithms that may be employed solely or in conjunction with one another include artificial neural networks, nearest neighbor methods, ensemble random forests, support vector machines, naive Bayes methods, linear regressions, or any other machine learning techniques or combinations thereof capable of predicting an output based on the inputted features. Determining which machine learning methods to use may depend on the specific purpose or functions required within change control system 120. The machine learning component, in some examples, outputs a similarity score that can be used to determine if the submission should be rejected. In other examples the machine learning component may output a decision such as reject, accept, or needs further review. Other outputs with a similar purpose may exist and are contemplated herein.

Once change control system 120 has performed the machine-learning based behavior analysis, the submission is classified based on defined thresholds, which may be performed within the machine learning module in some examples, wherein the classification of a submission is a learned skill within the machine learning module. In other examples, classification may be performed external to the machine learning methods based on user-defined, hard-coded, or other threshold-based determinations. The submission is classified into one of three groups: accept, reject, or needs further review, in some embodiments. Based on the classification of the change package submission, the change is accepted to computing operations environment 130, rejected, or deferred for further review. In some examples, the result, such as the classification, is reported back to another component of change control system 120, computing operations environment 130, change submission environment 110, or a user of the change control environment to be accepted, rejected, or deferred. Alternatively, the submission may be accepted, rejected, or deferred automatically upon the classification by the behavior analysis system.

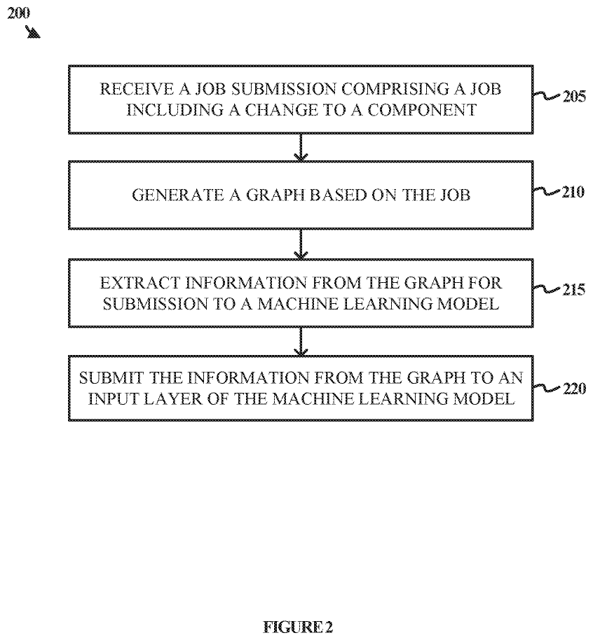

FIG. 2 illustrates process 200 for submitting a job to a behavior analysis component of a change control system. In step 205, the change control system receives a job submission comprising a job including at least one change to a component within a system associated with the change control system. The job submitted may comprise a proposed change to an environment associated with the change control system, such as a change to a cloud operations environment. In step 210, the system generates a graph based on the job. The graph serves as a representation of the job submission, wherein attributes of the submission are represented in the graph. In some embodiments, a data normalization step may exist between step 205 and 210 in which attributes may be normalized such that the graph is suitable for input into a machine learning algorithm. During data normalization, input attributes may be transformed such that they are represented as common values in a defined data schema. Normalization may include weighting attributes, handling excess attributes (e.g., if there are thirty possible attributes and the present submission has only five attributes, the data in the submission may be normalized such that the values of attributes match the expected input to the machine learning module). In the normalization step, expected attributes that do not apply to the present submission may be included but given zero inputs or zero weight.

As previously mentioned, the graph serves as a representation of the submitted job that is easy to understand compared to the original submission. In some examples, the graph may allow users to visualize the job and its behavior. The graph-based attributes are represented numerically within the graph. Using the graph, the machine learning module can extract values much faster than traditional methods once it has been trained.

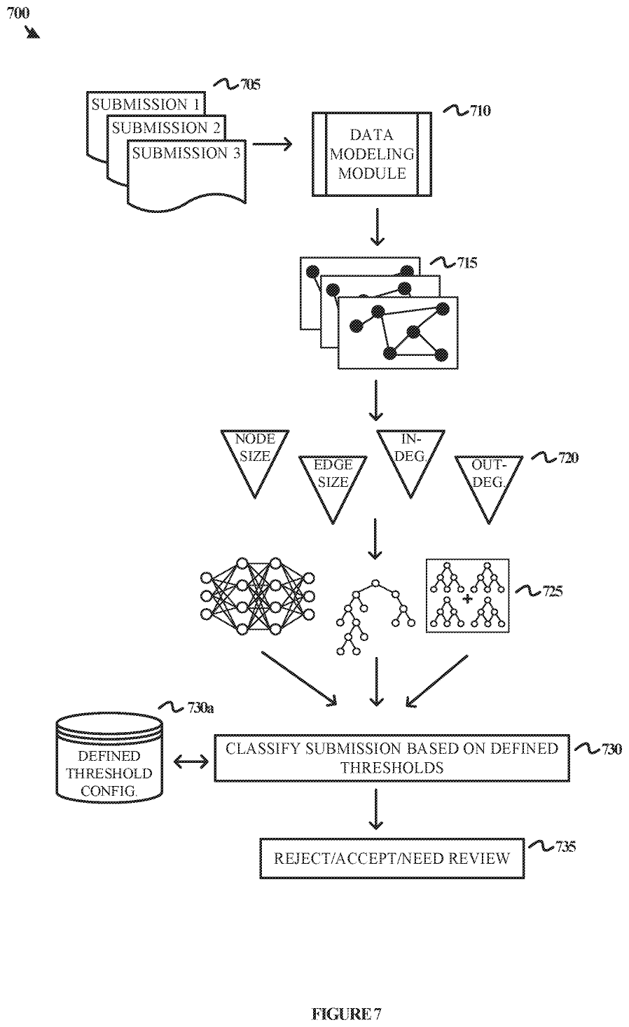

After the graph is generated, and in some examples, after the graph data is normalized, the system extracts information from the graph for submission to a machine learning model that evaluates the information to determine if the job submission should be rejected in step 215. In step 220, the system submits the information extracted from the graph to an input later of the machine learning model. Submitting information to an input layer of a machine learning model will be discussed further with reference to FIGS. 7 and 8.

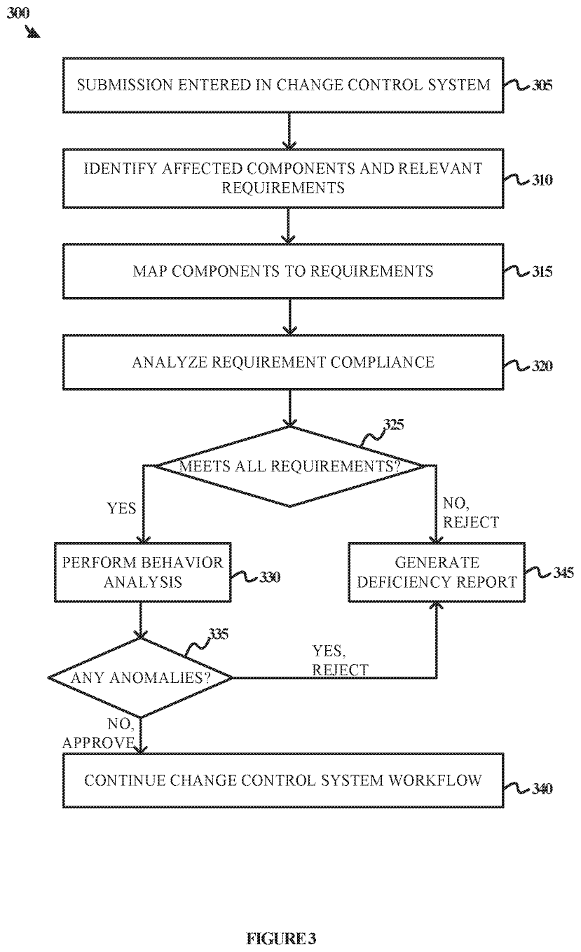

FIG. 3 illustrates analysis system workflow 300 for accepting or rejecting changes submitted to a change control system. In step 305, a submission is entered into the change control system. The submission may be a job, change, package, or similar type of submission to an environment associated with the change control system. The job, change, package, or similar submission may comprise a change to the environment, component of the environment, code, configuration, or a similar aspect of the environment or combinations thereof. In step 310, the system identifies the affected components and relevant requirements. In some examples, this step further includes checking that the components are mapped to the relevant requirements. The relevant requirements may be any set of attributes defining controls that must be analyzed and validated against the submission. The controls may be specific to the environment, to the component, or to another aspect associated with the submission. The requirements may be stored in a requirements list or determined in another manner. The set of requirements may be based on industry certification, regulations, requirements, data points, or other requirements entered or configured into the system. The system may then match the relevant requirements to the submission or to information in the submission.

In step 315, the system maps the components to the requirements discussed above, wherein the requirements may be stored in a requirements list or in an alternative manner. In step 320, the system analyzes the requirement compliance. In step 325, the system determines if the submission meets all the requirements. If the submission does not meet all the requirements, the system rejects the submission and generates a deficiency report. In some examples, the deficiency report may include information as to why the submission did not meet each the requirements and may generate an alert or send the information to relevant parties. Alternatively, if the submission does meet all the requirements, it may proceed to behavior analysis in step 330. In some embodiments the behavior analysis step employs machine learning techniques to analyze attributes and/or features of the submission to determine a likelihood of failure.

The machine learning-driven behavior analysis is based on previous submissions that have succeeded or failed. Using graph-based machine learning techniques, the system may determine the breadth of issues or failures that could be caused by the submission. To achieve this, the system determines, at least in part, if there are any anomalies in the submission that could produce undesired results in step 335. Anomalies may be any abnormalities known to cause issues or are unknown to the system and therefore have unknown consequences. Since the machine learning algorithm is trained using historical submissions, anomalies may comprise one or more features or attributes that are unknown or unusual within the system. Anomalies may also comprise features or attributes that are known but have been identified as problematic or failure-inducing. If it is determined that anomalies are present in the submission, the system generates a deficiency report in step 345. As previously discussed, the deficiency report may describe why the submission was rejected, any identified anomalies, or similar information related to the rejection. If no anomalies are found to the be present in the submission, the submission is approved, and the change control system workflow is continued in step 340.

In some embodiments, analysis system workflow may include a third option at step 335. If the system does not determine that the submission should be rejected or approved, it may determine that further review is required for a variety of possible reasons including producing a similarity score between the determines ranges for rejection and submission, having unknown qualities, or otherwise.

FIG. 4 illustrates graph 400 which serves as an example of a graph representing a job submission to a change control system. Graph 400 serves solely for purposes of explanation; a graph generated based on a job submission to a change control system may include many more nodes, edges, and components than shown in the present example. Graph 400 includes user node 405 comprising information about the user who submitted the job. The user information of the present example includes username, email, role, job title, and similar information. In some examples, multiple user nodes may exist for a submission comprising information about other users who have interacted with the job such as editors, contributors, supervisors, and the like.

Graph 400 includes past submission node 410, past submission node 415, and past submission node 420, wherein each past submission node is associated with the user node via an edge. The present example comprises only undirected edges, although directed edges may be used within graph 400 and are anticipated. Each past submission node comprises information about a previous submission associated with the user. Past submission information includes time of past submission, approval status of the past submission, and similar information that may be relevant to the likelihood of failure or success for the submission represented by graph 400.

Each of the past submission nodes in the present example is associated with a requirement node via an edge. Past submission node 410 is associated with requirement node 425, past submission node 415 is associated with requirement node 430, and past submission node 420 is associated with requirement node 435. The requirement nodes include information about which requirements were relevant to the associated submission. As discussed previously, when a job is submitted, the system may identify affected components and relevant requirements and map the components to the requirements. In the present example, the submission represented in past submission node 410 was subject to requirement 2, requirement 4, requirement 15, and additional requirements not mentioned here for the sake of brevity, as shown by requirement node 425. The submission associated with past submission node 415 was subject to requirement 1, requirement 2, and additional requirements, as shown by requirement node 430. The submission of past submission node 420 shown in the present example was subject to requirement 1, requirement 4, requirement 18, and additional requirements as shown by requirement node 435.

In addition to the requirements associated with previous jobs submitted by the user of the present example, user node 405 is shown to be associated with a set of requirements 1, 4, and 18 in requirements node 440. The user of the present example is also shown to be associated with two organizations as shown by the organization node 445 and organization node 450 of graph 400. The organization nodes are each associated with user node 405 node via an edge. Each of the organization nodes of the present example includes information regarding the name and location of the associated organization. Additional information may also be included about the organization but is left out here for the sake of brevity.

Nodes may be used for a variety of purposes within graphs in accordance with the present technology. A graph representing a submission to a change control system may include nodes related to the history of the submission, users, lines of code, features of the code, organization, location, date and time, and many other factors relevant to the submission. For example, a node may indicate that a user has many successful submissions and zero failed submissions. However, another node in the graph may indicate that the submission has an extremely large number of lines of code, which is unusual. Another node may identify that a component of the submission has been identified as risky. Any number of nodes may exist for a submission, and each node may be calculated and appropriately weighted to inform an aggregate decision of whether or not the submission should be approved. Although in the present example, the submitter has many successful submissions and no failed submissions, the system may ultimately determine that the submission should be rejected because with combined and weighted decision comes out below a desired threshold.

Edges in a graph, such as those in graph 400, represent relationships between different nodes. For example, a graph may have a user node and an organization node with an edge between them indicating that the user belongs to the organization. There may an edge from a user to a node indicating that the user has six previously successful submissions. There may be edges from the user to the code itself, to a node indicating that there are six million lines of code, or to a node representing a specific component of the submission, as just a few examples. Edges may be useful in identifying usual and unusual features of a submission. In the present example, there may be an edge between the user and a component that the user has never been connected to before, and this aspect may be weighted and considered in the behavior analysis process. As previously mentioned, the edges discussed herein may be directed or undirected.

In order to represent jobs submitted to a change control system as graphs, a graph generation module or similar component for generating graphs may be trained based on data from the change control system. Graph creation is a preprocessing component of the system that includes data preprocessing and feature engineering. During data preprocessing, the system may handle null values and/or categorical variables, standardize data value types, and perform similar preprocessing-related processes. The feature engineering step serves to refine raw-data or input features into a useful format for input to a machine learning or training model. During a feature engineering process, features are extracted from a raw dataset in preparation of a proper input dataset compatible with requirements of a machine learning model or training model. In the feature engineering step, nodes and edges may be defined, attributes for each node and edge may be defined, and which attributes can be used as valid features for input to the machine learning model maybe defined. Feature engineering may also be utilized for purposes of improving machine learning model performance in some examples. Furthermore, the feature engineering step described herein may include selecting attributes, encoding categorical attributes into multiple attributes, and similarly related processes.

During graph generation, the set of attributes comprised in each submission may differ. For this reason, the set of attributes may be normalized such that any submission can be modeled in a graph. Because the system learns how to form graphs based on data from the change control system, graph generation processes may continue to improve over time or be retrained over time. Identifying what attributes should and/or can be used to populate the graph may be an automatic or manual process depending on the specific embodiment.

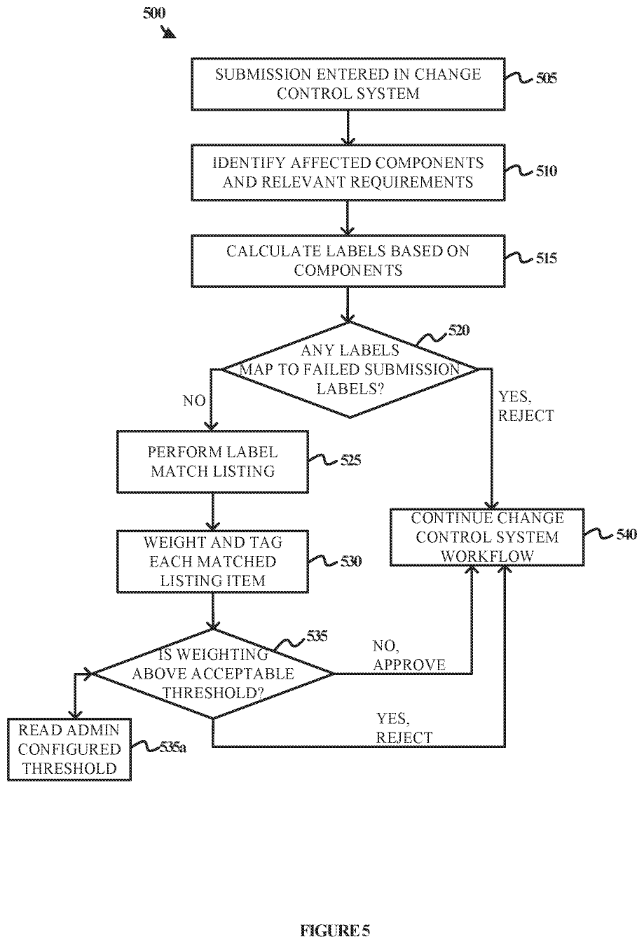

FIG. 5 shows failed submission flow 500 demonstrating a process by which a system in accordance with the embodiments disclosed herein may perform label matching and weighting to determine if a submission should be rejected. In step 505, a submission is entered in the change control system. The submission may be any job, change, package, or similar submission to a computing environment such as a cloud operations environment. In step 510, the system identifies affected components and relevant requirements. In some embodiments, a data normalization step may exist between step 505 and step 510 in which attributes may be normalized such that the graph is suitable for input into a machine learning algorithm. Based on the submission, the system then calculates labels based on the components in step 515. In some examples, the labels correspond to node labels in a graph as disclosed herein. The labels may correspond directly to requirements that indicate if the submission should be rejected. Thus, in step 520 the system checks if any labels map to failed submission labels. If any labels calculated map to failed submission labels, the submission is rejected, and the system may continue the change control system workflow in step 540.

Alternatively, if none of the labels map to failed submission labels, the process continues to step 525 wherein the system performs a label match listing. Once the labels have been matched to list items, each matched listing item is weighted and tagged in step 530. Similar to previous examples, there may also be a third result indicating that the submission should be passed on for further review. The various weights are processed within the system to create an aggregate weighting which is ultimately used to determine if the submission should be approved or rejected. In step 535, the system determines if the aggregate weighting is above the acceptable threshold based on a reading of administrator-configured thresholds in step 535a. This determination may be based on a reading of an administrator configured threshold, a pre-determined threshold, a learned threshold, or similar threshold or combinations thereof. If the aggregate weighting is above the acceptable threshold, the submission is rejected, and the system continues the change control system workflow in step 540. If the aggregate weighting is not above the acceptable threshold, the submission is approved in the system continues the change control system workflow in step 540.

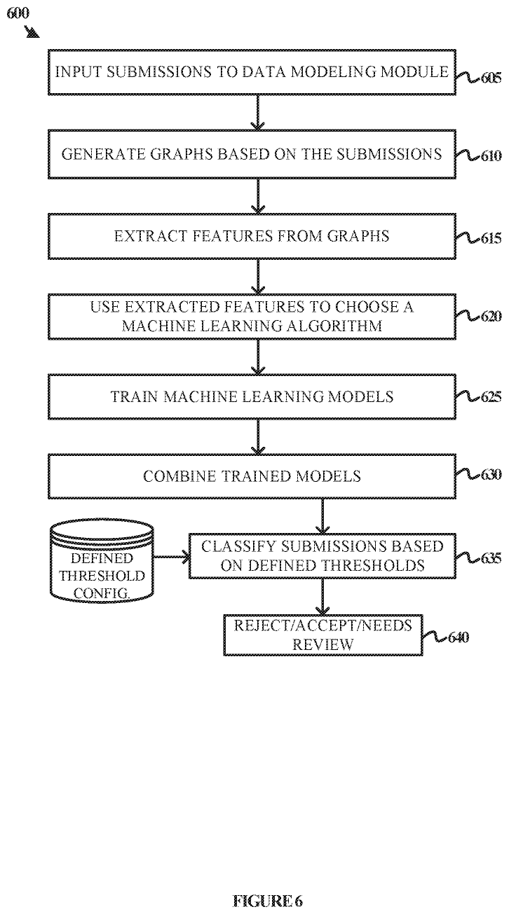

FIG. 6 illustrates data modeling workflow 600 for training one or more machine learning models to perform behavior analysis using historical or labeled data in accordance with embodiments of the technology disclosed herein. In step 605, submissions are input to a data modeling module. The submissions may be any previous submission, historical change control submission, or similar, labeled submission that can be used to train a behavior analysis model. There may be any number of submissions entered into the data modeling module to train the system, although more labeled submissions may improve the accuracy or efficiency of the data modeling process in accordance with the present example. In step 610, the system generates graphs based on the submissions. In the present example, one graph is generated per submission, wherein the one graph per submission represents an entire submission. However, it is anticipated that in other examples, a plurality of graphs may be used to represent a single submission, and one or more graphs may represent a portion of a submission. The graph generated for each submission of the present example may be similar to the graph 400 in FIG. 4.

In step 615, the system extracts features from the graphs. Features may be extracted from each graph generated for input into one or more machine learning models. Machine learning models used herein may include at least one of an artificial neural network, nearest neighbor methods, ensemble random forests, support vector machines, naive Bayes methods, linear regression methods, or additional machine learning techniques capable of predicting an output based on inputted features. In the present example, the features extracted from each graph are used to determine at least one machine learning algorithm to perform behavior analysis. In some examples, more than one machine learning algorithm may be used. In step 625, the system uses the features extracted from the graphs to train the one or more machine learning models.

In an exemplary embodiment, the submissions that the graphs are based on previously inspected submissions that have been labeled as having failed, succeeded, rejected, accepted, needing further review, or a similar label that can be used to train a machine learning module to reject, accept, or defer submissions based on their likelihood of failure. The submissions may be submissions previously entered into the present change control system. The submissions may have been manually inspected or labeled in some embodiments.

In step 630, the system combines machine learning models chosen in step 620. The machine learning models may be combined to create an optimized behavior analysis system, or the models may be combined during post-processing to generate an aggregate result. In step 635, the system uses one or more defined threshold configurations to classify the submissions based on the defined thresholds. The classification of each submission is used to ultimately determine if each submission should be rejected, accepted, or needs further review in step 640. An additional data modeling workflow is provided in FIG. 7.

FIG. 7 illustrates data modeling workflow 700. In data modeling workflow 700, submission 1, submission 2, and submission 3 are entered into a data modeling module in step 705. The submissions may take many different forms or be in different file formats including a log of the history of the job and/or submission. The files submitted with a change package submission may not be in a form readily usable by the behavior analysis system discussed in the present example. For this reason, the data modeling module processes each of the submissions in step 710. In step 715, data modeling module outputs a graph based on each submission in step 715. Each of the graphs has a set of nodes and connecting edges comprising information about the submission. Once a graph is generated for each submission by the data modeling module, attributes are extracted from the graphs in step 720. Attributes extracted from the graphs may include user attributes, submission history, organization attributes, relevant requirements, and similar attributes or attributes previously discussed. Attributes may further include information regarding node size, edge size, in-degree of nodes, out-degree of nodes, and similar data represented by the graph that may be useful in determining a likelihood of failure.

Once the features have been extracted from the graphs, they are used to choose one or more machine learning algorithms and then processed by the one or more chosen machine learning algorithms in step 725. The one or more machine learning algorithms process the information for each submission based on the inputted features in order to determine a similarity score for and classify each of the submissions based on defined thresholds in step 730, wherein the defined thresholds may be retrieved from a set of defined threshold configurations in step 730a. The similarity score used to classify each submission may represent how similar a submission is to previously failed submissions or how similar a submission is to previously successful submissions. In other scenarios, the similarity score may represent an aggregate score of how similar aspects of the submission are to aspects of previous submissions. Once the submission has been classified, the submission may be rejected, accepted, or flagged for further review in step 735.

FIG. 8 illustrates behavior analysis environment 800 in accordance with some embodiments of the present technology. Behavior analysis environment 800 includes graph 805, attributes list 810, and artificial neural network 815. Graph 805 includes a set of nodes and edges representing a job submission in a change control system. User node 806 and edge 807 serve as examples of nodes and edges, respectively, that may exist in a graph in accordance with embodiments of the present technology. Graph 805 may comprise similar qualities to graph 400 in FIG. 4. The nodes and edges of graph 805 represent attributes and/or features of the job submitted to the change control system of the present example. The job submission may be any job, change, package, code, configuration, or similar submission to the change control system, wherein the change control system is associated with a software environment such as a cloud operations system, as one example. In some examples, changes submitted to a change control system may include changes or updates to a firewall, routing table, component within the environment, or similar aspect of an environment or combinations thereof. Once a change is submitted, the system of the present example may determine, using machine learning techniques, if the submission is likely to fail based on historical data or similar changes. The system may, at least in part, determine if a submission is high-risk or if it comprises any anomalies based on attributes found in the submission.

Graph 805 includes nodes labeled code, program, lines, user (i.e., user node 806), group, department, organization, editor 1, location, and internet protocol address (IP). The nodes of graph 805 are provided solely for purposes of explanation and are not intended to limit the nodes that may be used in other implementations. Graphs in other examples may comprise additional nodes, fewer nodes, different types of nodes, and variations or combinations thereof. The nodes of graph 805 are labeled according to what information may be comprised within them. In an exemplary embodiment, information stored in graph 805 is represented in a metadata format such that the information may be easily digestible by a system when analyzing or processing data in the graph. A graph representing a submission to a change control system may comprise any number of nodes and, in some examples, includes many more nodes than are shown in the present example of graph 805. Graph 805 includes both directed (e.g., edge 807) and undirected edges representing relationships between nodes within the graph. For example, edge 807, a directed edge, exists between the user node and the code node of the present example, indicating that the user submitted the code of the present example. Another edge exists between the user and group node, indicating that the user is associated with the group described in the group node, as an example.

Attributes may be extracted from graph 805, as illustrated in attributes list 810. Although in the present example attributes list 810 includes nodes and their labels from graph 805, the attributes extracted from a graph such as graph 805 may include any feature of the graph. For example, attributes extracted may include node labels, such as group attribute 811, information stored within the nodes, edges, or a number of nodes, a number of edges, in-degree of nodes, out-degree of nodes, or any similar type of information that may be included in a graph such as graph 805. Information may be extracted from graph 805 according to a set of inputs to a behavior analysis model, such as artificial neural network 815. Artificial neural network 815 may have a pre-defined or dynamic set of inputs, a static input layer, a dynamic input layer, or any similar type of input layer or combination thereof. Input layer 816 of artificial neural network 815 is shown solely for purposes of explanation, and it is anticipated that an input layer in accordance with the present technology may include many more inputs than shown in the example of FIG. 8.

Artificial neural network 815 performs change control behavior analysis processes in accordance with the technology described herein. Artificial neural network 815 may represent any machine learning model or combinations of machine learning models that could be used in accordance with the present technology. In some examples, behavior analysis performed by artificial neural network 815 includes a similarity matching and/or a ranking that may be outputted through output layer 817 in some examples. The machine learning model may predict a similarity score of one or more previously failed or previously accepted submissions, wherein the similarity score is ultimately used to approve, reject, or indicate that a submission needs further review, wherein the classification component may be determined using machine learning techniques, or may be external to the machine learning model, such as manually determined based on the similarity score or determined using hard-coded logic. The machine learning algorithm may be trained to determine proper thresholds for rejection or acceptance through training.

Submissions to change control systems often include enormous amounts of data, making it difficult and time-consuming to manually analyze the information and determine if a submission is likely to fail. There may be a wide breadth of data points stored in a graph such as graph 805 and a submission may include many thousands of features in some examples, making it difficult to determine if the submission should be accepted or rejected in a simple manner. Thus, using machine learning techniques to perform submission analysis enables all relevant features to be compared to previous submissions. A machine learning algorithm may, over time, determine which elements, attributes, nodes, or other features of the graphs submitted have strong correlations to a likelihood of success and which do not, and set weights within the model accordingly.

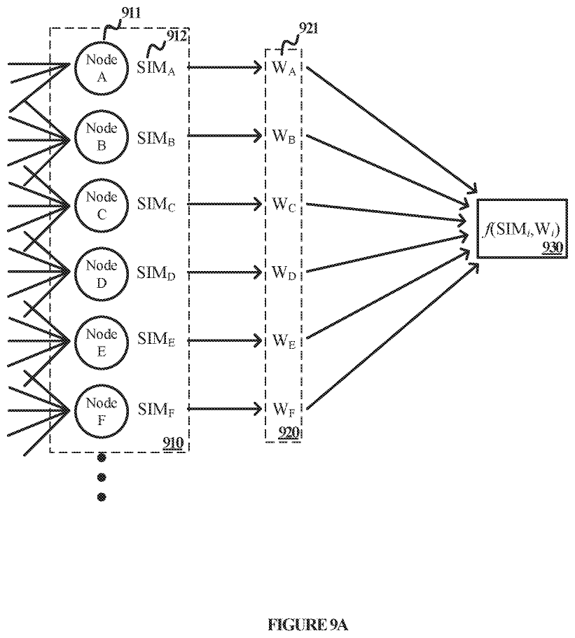

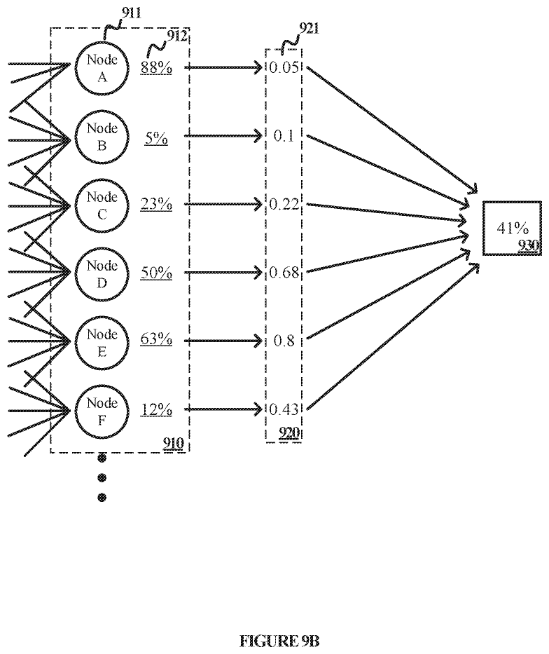

Within artificial neural network 815, multiple similarity scores may be generated based on the inputs and processing performed in the behavior analysis model. For example, the inputs of artificial neural network 815 may correlate to the outputs of output layer 817 of artificial neural network 815. The multiple similarity scores may be combined to form an aggregate similarity which can then be used to classify the submission as one of: reject, approve, or defer for further analysis. In some examples, training data may include a set of accepted submissions, a set of rejected submissions, and a set of submissions requiring further review, wherein these sets are used to classify a present submission based on which set the submission is most similar to. For example, if eighty percent of a submission is similar to failed submissions, twenty percent of the submission is similar to submissions that needed further review, and sixty percent of the submission is similar to successful submissions, the artificial neural network may determine that the submission is most similar to failed submissions and therefore rejected the proposed change. An example of submission classification based on similarity scores is discussed further with respect to FIG. 9.

The processing performed by artificial neural network 815 is not a code review. Code review may be performed before submission to the change control system, in some examples. Since the role of the change control system is to look for high-level systemic issues, such as compliance, auditing, and risk-related problems, artificial neural network 815 utilizes information relevant to at least those aspects of the submission and how it will behave within the system to which it is proposed.

FIG. 9A illustrates an example of an output of a machine learning model, wherein output layer 910 is used to predict an overall similarity score. Output layer 910 includes node A (i.e., node 911), node B, node C, node D, node E, node F, and additional nodes not shown in the present example for purposes of clarity. Each node includes a predicted similarity score for the feature described by that node. For example, node 911 has predicted similarity score 912, SIM_{A}. Similarity scores may be represented in a variety of manners such as a number value that may then be mapped to a meaningful representation of similarity. The similarity score may signify how similar the feature is to the corresponding feature of previously failed submissions, how likely that feature is to cause failure, or a similar representation related to a likelihood of failure or a combination thereof. In other embodiments, the similarity scores may represent a likelihood of success rather than a likelihood of failure. In yet another embodiment, the similarity scores may not directly represent a likelihood, but may be numeric values that map to ranges corresponding to failure, success, or other representations.

The plurality of similarity scores associated with an output layer of the machine learning model are then weighted with their associated weight from weights 920. For example, node 911 (node A) having similarity score 912 (SIM_{A}) is weighted with weight 921 (W_{A}) before being inputted to the function that predicts aggregate similarity score 930 (f [SIM₁, ZWᵢ]). The weights used to arrive at aggregate similarity score 930 are ultimately used to determine if the submission should be rejected, accepted, or left for further review. Aggregate similarity score 930 is a function of the plurality of similarity scores and their weights. Aggregate similarity score 930, like the plurality of individual similarity scores, may represent how likely the submission is to fail or succeed, how similar it is to previously failed or successful submissions, or a similar indication that may be used to accept or reject the submission. The weights used to determine the aggregate similarity score may be determined during training of the machine learning model similar to other weights used within the machine learning model. In other examples, the weights used to determine an aggregate similarity score may not be determined using machine learning techniques. The scores, values, and methods used to determine if a submission should be rejected, accepted, or deferred for further review as shown in FIG. 9 may deviate from the present example while still being in accordance with the technology disclosed herein.

FIG. 9B illustrates an example of FIG. 9A using exemplary numeric values. The numbers and numeric representations used in the example of 9B are shown solely for purposes of explanation and actual values may be represented in many different manners departing from the methods used in the present example. SIM_{A} through SIM_{F} are expressed as percentages representing the similarity score for each attribute representing by their respective nodes. Actual similarity scores output by the machine learning model may be expressed in a variety of manners including but not limited to percentages, numeric values, alpha-numeric values, or other means of representing a score that can be mapped to a meaningful representation of similarity. In order to calculate aggregate similarity score 930, each individual similarity score is passed through the corresponding weight of weights 920. Weights 920 are expressed as decimal numbers in the present example but may take many varying forms or numeric styles in other examples. The similarity scores of output layer 910 and weights 920 are used to calculate aggregate similarity score 930, which is 41% in the present example. Aggregate similarity score may then be used to classify the submission as reject, accept, or needs further review based on manually defined thresholds, pre-defined thresholds, learned thresholds, and variations or combinations thereof. Like the other numbers used in the present example, aggregate similarity score 930 may be expressed in many different forms that map to a meaningful classification of a submission. The actual implementation of how a similarity score is expressed may depart from the present example.

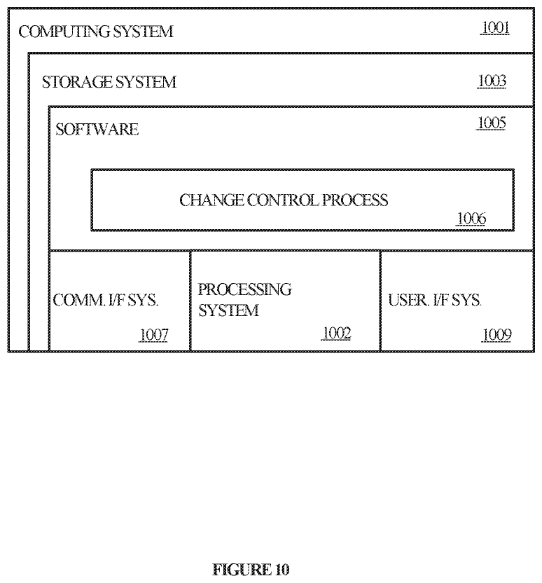

FIG. 10 illustrates computing system 1001 that is representative of any system or collection of systems in which the various processes, systems, programs, services, and scenarios disclosed herein may be implemented. Examples of computing system 1001 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements process 1006, which is representative of the change control processes discussed with respect to the preceding Figures. When executed by processing system 1002 to provide change control functions, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing a change control system as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 901 is representative) overall from a general-purpose computing system into a special-purpose computing system customized to provide application isolation and/or provisioning as described herein. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of cloud storage and/or datacenters, it should be understood the change control systems and methods described herein are not limited to such embodiments and may apply to a variety of other change control environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A change control system comprising:
one or more computer-readable storage media;
a processing system operatively coupled with the one or more computer-readable storage media; and
program instructions stored on the one or more computer-readable storage media that, when read and executed by the processing system, direct the processing system to at least:
receive a job submission, wherein the job submission comprises a job including at least one change to a component within a system associated with the change control system;
generate a graph based on the job;
extract information from the graph for submission to a machine learning model; and
submit the information from the graph to an input layer of the machine learning model, wherein the machine learning model evaluates the information from the graph to predict if the submission should be rejected.

2. The change control system of claim 1, wherein the machine learning model, based on similarities between the information from the graph and information from one or more previous job submissions, determines a similarity score.

3. The change control system of claim 2, wherein the program instructions stored on the one or more computer-readable storage media further direct the processing system to reject the job submission, accept the job submission, or defer the job submission for further review based on the similarity score and a set of defined thresholds.

4. The change control system of claim 1, wherein the machine learning model includes at least one of: an artificial neural network, gradient boosting decision trees, and an ensemble random forest.

5. The change control system of claim 1, wherein:
the machine learning model is trained using historical change control system data; and
the historical change control system data includes previously rejected job submissions and previously accepted job submissions.

6. The change control system of claim 1, wherein:
the graph comprises a plurality of nodes and a plurality of edges, the plurality of nodes and the plurality of edges comprising information about the job; and
each node of the plurality of nodes is based on learned attributes related to, at least in part, one or more users, components, timing attributes, or requirements.

7. The change control system of claim 1, wherein extracting information from the graph and submitting the information from the graph to the input layer of the machine learning model is based on a mapping of nodes from the graph to specific inputs of the input layer of the machine learning model.

8. A method of operating a change control system, the method comprising:
receiving a job submission, wherein the job submission comprises a job including at least one change to a component within a system associated with the change control system;
generating a graph based on the job;
extracting information from the graph for submission to a machine learning model; and
submitting the information from the graph to an input layer of the machine learning model, wherein the machine learning model evaluates the information from the graph to predict if the submission should be rejected.

9. The method of claim 8, wherein the machine learning model, based on similarities between the information from the graph and information from one or more previous job submissions, determines a similarity score.

10. The method of claim 9, further comprising rejecting the job submission, accepting the job submission, or deferring the job submission for further review based on the similarity score and a set of defined thresholds.

11. The method of claim 8, wherein the machine learning model includes at least one of: an artificial neural network, gradient boosting decision trees, and an ensemble random forest.

12. The method of claim 8, wherein:
the machine learning model is trained using historical change control system data; and
the historical change control system data includes previously rejected job submissions and previously accepted job submissions.

13. The method of claim 8, wherein:
the graph comprises a plurality of nodes and a plurality of edges, the plurality of nodes and the plurality of edges comprising information about the job; and
each node of the plurality of nodes is based on learned attributes related to, at least in part, one or more users, components, timing attributes, or requirements.

14. The method of claim 8, wherein extracting information from the graph and submitting the information from the graph to the input layer of the machine learning model is based on a mapping of nodes from the graph to specific inputs of the input layer of the machine learning model.

15. One or more computer-readable storage media having program instructions stored thereon to facilitate change control processes that, when read and executed by a processing system, direct the processing system to at least:
receive a job submission, wherein the job submission comprises a job including at least one change to a component within a system associated with a change control system;
generate a graph based on the job;
extract information from the graph for submission to a machine learning model; and
submit the information from the graph to an input layer of the machine learning model, wherein the machine learning model evaluates the information from the graph to predict if the submission should be rejected.

16. The one or more computer-readable storage media of claim 15, wherein the machine learning model, based on similarities between the information from the graph and information from one or more previous job submissions, determines a similarity score.

17. The one or more computer-readable storage media of claim 16, wherein the program instructions, when read and executed by the processing system, further direct the processing system to reject the job submission, accept the job submission, or defer the job submission for further review based on the similarity score and a set of defined thresholds.

18. The one or more computer-readable storage media of claim 15, wherein the machine learning model includes at least one of: an artificial neural network, gradient boosting decision trees, and an ensemble random forest.

19. The one or more computer-readable storage media of claim 15, wherein:
the machine learning model is trained using historical change control system data; and
the historical change control system data includes previously rejected job submissions and previously accepted job submissions.

20. The one or more computer-readable storage media of claim 15, wherein:
the graph comprises a plurality of nodes and a plurality of edges, the plurality of nodes and the plurality of edges comprising information about the job; and
each node of the plurality of nodes is based on learned attributes related to, at least in part, one or more users, components, timing attributes, or requirements.
